(19) United States
(12) Patent Application Publication
(10) Pub. No.: US 2009/0206994 A1
(43) Pub. Date: Aug. 20, 2009

(54) CARD HAVING RFID TAG

(75) Inventor: Kuo-Chih LEE, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/031,911

(22) Filed: Feb. 15, 2008

(51) Int. Cl. H04Q 5/22

(52) U.S. Cl. 340/10.1

(57) ABSTRACT

A card having radio frequency identification (RFID) tag receives a first electrical signal having a first message sent by a RFID reader and returns a second electrical signal having a second message to the RFID reader in response to the first electrical signal. The card having RFID tag includes a coil, a microprocessor chip, a switch, and a display. The microprocessor chip is disposed in the card and electrically connected to the coil. The switch is disposed between the coil and the microprocessor chip. The display is controlled by the microprocessor chip to display the first message or the second message. The switch is used to control whether to start the RFID tag or not, and then the display displays the transmitted or received message, so as to protect data from being stolen and efficiently control the transmitted and received messages.

### BACKGROUND OF THE INVENTION

1. Field of the Invention

The present invention relates to a card having a RFID tag, and more particularly to a card capable of displaying information and having a hardware switch to control the function of the RFID tag.

2. Related Art

Radio Frequency Identification (RFID) refers to a kind of radio technology built in chips, and the chip may further record a series of information such as names of products, positions, and dates. Its most significant advantage is to enhance goods management efficiency. Currently, information about goods is mostly recorded with bar codes, and thus, the information may be obtained by using a scanner to scan the bar codes. However, RFID is capable of sensing objects merely within a specific range and obtaining a large amount of information at one time. The RFID technology may be applied in access control, general coupons and tickets, and transportation.

A RFID system mainly includes a tag, a reader, and a computer host. The tag is an element for storing data, the reader is a tool for reading data from the tag or storing data into the tag, and the reader is used to transmit the read data into a computer system, so as to interpret the data through using different applications and assist the user to make a correct decision rapidly. Tags may be classified into active tags and passive tags. An active tag contains a battery and may transmit information to the reader at any moment, and has a long communication distance, so it may have a large memory, but its price is relatively high. As for a passive tag, the sensation micro-current generated by the electric waves sent from the reader to the passive tag acts as a power source for the tag, and then the information is returned to the reader by using the electric waves, however, its communication distance is relatively short. The passive tag has the advantages of requiring no additional battery, having a small volume, a low price, a long service life, and having portability of the digital data. The passive tag has a built-in antenna to sense and generate radio waves for receiving and transmitting data.

At present, the card having the RFID tag starts the RFID tag function by using an alternating magnetic field generated by the reader, and no control switch is specifically designed on the card for controlling whether to start the RFID tag function or not. As a result, for the current products with the RFID tag function such as electronic wallets or entrance guards, any one who has a card-reading system meeting the RFID tag specification is capable of reading information and messages in the card within the communication distance, so the products are not safe enough. Currently, when the RFID is used to transmit data, the card having the RFID tag function cannot display the messages about the transmitting/receiving of the data in the card. As a result, the card holders cannot learn about and grasp the contents of the received and transmitted messages merely through the card having the RFID tag. For example, when an electronic wallet having the RFID tag function is used in the transaction, the amount deducted in the current transaction and the balance in the card cannot be known immediately, and the user cannot learn about the information in the electronic wallet efficiently.

### SUMMARY OF THE INVENTION

In view of the aforementioned problem, the present invention is directed to a card having a RFID tag, which is capable of preventing others from reading the data in the tag by using an applicable RFID reader, and capable of enabling a holder of an electronic device to know messages received by the RFID tag from the RFID reader or messages transmitted from the RFID tag to the RFID reader.

The present invention provides a card having RFID tag, which is used to receive a first electrical signal having a first message sent by a RFID reader and to return a second electrical signal having a second message to the RFID reader in response to the first electrical signal. The card includes a coil, a microprocessor chip, and a switch. The coil is disposed in the card and used to sense the first electrical signal, so as to form a first signal current having the first message. The microprocessor chip is disposed in the card and electrically connected to the coil. The microprocessor chip is used to interpret the first signal current transmitted by the coil, thereby generating a second signal current having the second message for the coil. Then, the coil generates a second electrical signal according to the second signal current and returns the second electrical signal to the RFID reader. The switch is disposed between the coil and the microprocessor chip, and used to control an electrical connection between the coil and the microprocessor chip.

The present invention provides another card having RFID tag, which is used to receive a first electrical signal having a first message sent by a RFID reader and to return a second electrical signal having a second message to the RFID reader in response to the first electrical signal. The card includes a coil, a microprocessor chip, and an electronic paper. The coil is disposed in the card and used to sense the first electrical signal, so as to form a first signal current having the first message. The microprocessor chip is disposed in the card and electrically connected to the coil. The microprocessor chip is used to interpret the first signal current transmitted by the coil, thereby generating a second signal current having the second message for the coil. Then, the coil resonates the second signal current to form a second electrical signal and returns the second electrical signal to the RFID reader. The electronic paper is disposed in the card and electrically connected to the microprocessor chip. The electronic paper is controlled by the microprocessor chip to display the first message or the second message.

In the present invention, the switch is used to control whether to start the RFID tag or not, and the display is used to display transmitted or received messages, so as to protect the data from being stolen and to efficiently control the transmitted and received messages.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a card having a RFID tag according to a first embodiment of the present invention;

FIG. 2 is a schematic view of a card having a RFID tag according to a second embodiment of the present invention; and

FIG. 3 is a schematic view of a card having a RFID tag according to a third embodiment of the present invention.

### DETAILED DESCRIPTION OF THE INVENTION

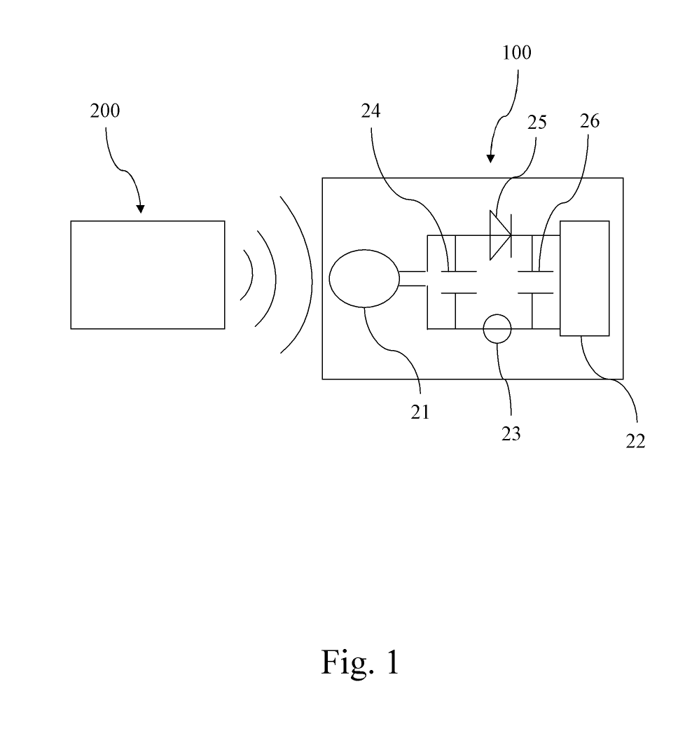

Referring to FIG. 1, it is a schematic view of a card having RFID tag according to a first embodiment of the present invention. In this embodiment, the card 100 having the RFID tag is used to receive a first electrical signal having a first message sent by a RFID reader 200 and to return a second electrical signal having a second message to the RFID reader 200 in response to the first electrical signal. The card 100 includes a coil 21, a microprocessor chip 22, and a switch 23. The coil 21 is disposed in the card 100 and used to sense the first electrical signal, so as to form a first signal current having the first message. The microprocessor chip 22 is disposed in the card 100 and electrically connected to the coil 21. The microprocessor chip 22 is used to interpret the first signal current transmitted by the coil 21, thereby generating a second signal current having the second message for the coil 21. Then, the coil 21 generates a second electrical signal according to the second signal current and returns the second electrical signal to the RFID reader 200. The switch 23 is disposed between the coil 21 and the microprocessor chip 22, and used to control an electrical connection between the coil 21 and the microprocessor chip 22.

The switch 23 may be a switcher, a button, or a resilient button. If the switch 23 is a switcher, the switcher forms an electrical connection between the coil 21 and the microprocessor chip 22 once it is switched, and then disconnects the electrical connection between the coil 21 and the microprocessor chip 22 once it is switched once again. If the switch 23 is a resilient button, the resilient button forms an electrical connection between the coil 21 and the microprocessor chip 22 when it is pressed and held, and disconnects the electrical connection between the coil 21 and the microprocessor chip 22 when it is not pressed.

Once the card 100 having the RFID tag in the present invention approaches the RFID reader 200, the coil 21 in the card 100 having the RFID tag senses an alternating magnetic field sent by the RFID reader 200, and then, an alternating current is generated in the coil 21 due to the electromagnetic induction effect. The energy carried by the alternating current is firstly stored in a first capacitor 24, and then released by the first capacitor 24 to form an alternating current. The alternating current is rectified and filtered by a rectifier and filter circuit formed by a diode 25 and a second capacitor 26, and then becomes a direct current to drive the microprocessor chip 22. Another function of the coil 21 lies in sensing the first electrical signal having the first message transmitted by the RFID reader 200, so as to form the first signal current having the first message and transmit the first signal current to the microprocessor chip 22. The microprocessor chip 22 responds the second signal current having the second message back to the coil 21 according to memory data in the microprocessor chip 22. Then, the coil 21 generates the second electrical signal according to the second signal current and returns the second electrical signal to the RFID reader 200.

The switch 23 is disposed between the coil 21 and the microprocessor chip 22 and used to control whether to start the RFID tag or not. When the RFID tag function of the card is to be used, the switch 23 is pressed to start the RFID tag function, thereby receiving the first electrical signal and returning the second electrical signal. When the RFID tag function of the card is not used, the switch 23 is pressed once again to stop the RFID tag function, so as to prevent others from reading the data stored in the card by using an applicable RFID reader.

In this embodiment, the switch 23 is used to control whether to start the RFID tag or not, thereby protecting the data from being stolen.

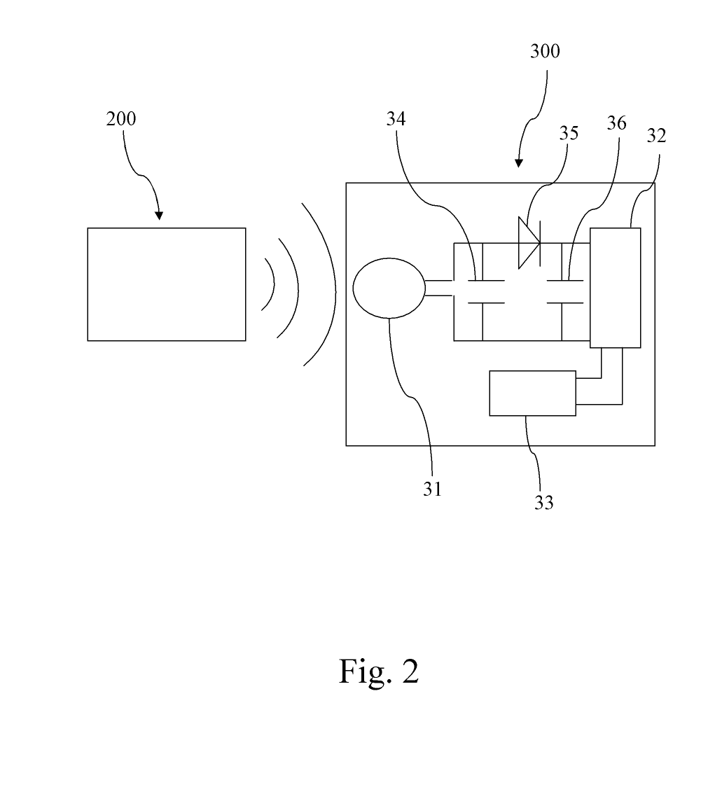

Referring to FIG. 2, it is a schematic view of a card having RFID tag according to a second embodiment of the present invention. The card 300 having the RFID tag in this embodiment is used to receive a first electrical signal having a first message sent by the RFID reader 200 and to return a second electrical signal having a second message to the RFID reader 200 in response to the first electrical signal. The card 300 includes a coil 31, a microprocessor chip 32, and an electronic paper 33. The coil 31 is disposed in the card 300 and used to sense the first electrical signal, so as to form a first signal current having the first message. The microprocessor chip 32 is disposed in the card 300 and electrically connected to the coil 31. The microprocessor chip 32 is used to interpret the first signal current transmitted by the coil 31, thereby generating a second signal current having the second message for the coil 31. Then, the coil 31 generates the second electrical signal according to the second signal current and returns the second electrical signal to the RFID reader 200. The electronic paper 33 is disposed in the card 300 and electrically connected to the microprocessor chip 32, which is controlled by the microprocessor chip 32 to display the first message or the second message.

The electronic paper 33 is formed by coating a kind of electronic ink on a conductive substrate. The electronic ink is formed by putting blue liquid and white fine particles into a transparent microcapsule, and once an external voltage is applied on the electronic ink, the fine particles in the capsule are made to move. When the microprocessor chip 32 receives the first signal current having the first message and responds the second signal current having the second message, different voltages are applied to each pixel on the electronic paper, so that the electronic paper displays the frame of the first message or the second message formed by two colors, i.e., white and blue. The electronic ink may also be formed by liquid and fine particles having other colors, thereby forming the frames with different colors.

Once the card 300 having the RFID tag in the present invention approaches the RFID reader 200, the coil 31 in the card 300 senses an alternating magnetic field sent by the RFID reader 200, and then, an alternating current is generated in the coil 31 due to the electromagnetic induction effect. The energy carried by the alternating current is firstly stored in a first capacitor 34, and then released by the first capacitor 34 to form an alternating current. The alternating current is rectified and filtered by a rectifier and filter circuit formed by a diode 35 and a second capacitor 36, and then becomes a direct current to drive the microprocessor chip 32. Another function of the coil 31 lies in sensing the first electrical signal having the first message transmitted by the RFID reader 200, so as to form the first signal current having the first message and transmit the first signal current to the microprocessor chip 32. The microprocessor chip 32 responds the second signal current having the second message to the coil 31 according to memory data in the microprocessor chip 32. Then, the coil 31 generates the second electrical signal according to the second signal current and returns the second electrical signal to the RFID reader 200. The electronic paper 33 on the card 300 is controlled by the microprocessor chip 32. Particularly, when the microprocessor chip 32 has interpreted the first signal current having the first message, it controls the electronic paper 33 to display the first message; when the microprocessor chip 32 responds the second signal current having the second message, it controls the electronic paper 33 to display the second message.

In this embodiment, the electronic paper 33 is used to display the transmitted or received messages, and thereby efficiently controlling the received and transmitted messages.

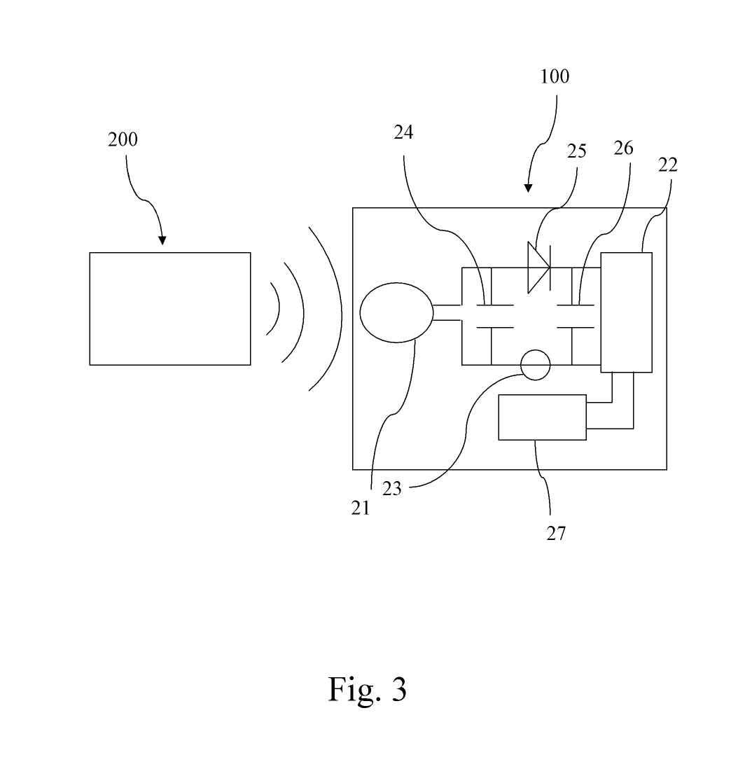

Referring to FIG. 3, it is a schematic view of a card having RFID tag according to a third embodiment of the present invention. The structure of the card 100 having the RFID tag in this embodiment is substantially the same as that in the first embodiment of the present invention, and the difference there-between lies in that the card 100 having the RFID tag in this embodiment further includes a display 27. The display 27 is disposed in the card 100 and electrically connected to the microprocessor chip 22, which is controlled by the microprocessor chip 22 to display the first message or the second message.

The display 27 may be an LCD or an electronic paper.

Once the card 100 having the RFID tag in the present invention approaches the RFID reader 200, the coil 21 in the card 100 senses an alternating magnetic field sent by the RFID reader 200, and then, an alternating current is generated in the coil 21 due to the electromagnetic induction effect. The energy carried by the alternating current is firstly stored in a first capacitor 24, and then released by the first capacitor 24, so as to form an alternating current. The alternating current is rectified and filtered by a rectifier and filter circuit formed by a diode 25 and a second capacitor 26, and then becomes a direct current to drive the microprocessor chip 22. Another function of the coil 21 lies in sensing the first electrical signal having the first message transmitted by the RFID reader 200, so as to form the first signal current having the first message and to transmit the first signal current to the microprocessor chip 22. The microprocessor chip 22 responds the second signal current having the second message to the coil 21 according to memory data in the microprocessor chip 22. Then, the coil 21 generates the second electrical signal according to the second signal current and returns the second electrical signal to the RFID reader 200. A switch 23 is disposed between the coil 21 and the microprocessor chip 22 and used to control whether to start the RFID tag or not. When the RFID tag function of the card is to be used, the switch 23 is pressed to start the RFID tag function, thereby receiving the first electrical signal and returning the second electrical signal. When the RFID tag function of the card is not used, the switch 23 is pressed once again to stop the RFID tag function, so as to prevent others from reading the data stored in the card by using an applicable RFID reader. The display 27 on the card 100 is controlled by the microprocessor chip 22. Particularly, when the microprocessor chip 22 interprets the first signal current having the first message, it controls the display 27 to display the first message, and when the microprocessor chip 22 returns the second signal current having the second message, it controls the display 27 to display the second message.

In this embodiment, the switch 23 is used to control whether to start the RFID tag or not, and the display 27 is used to display the transmitted or received messages, thereby protecting the data from being stolen and efficiently controlling the transmitted and received messages.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A card having a radio frequency identification (RFID) tag, for receiving a first electrical signal having a first message sent by a RFID reader and returning a second electrical signal having a second message to the RFID reader in response to the first electrical signal, the card having the RFID tag comprising:
a coil, disposed in the card, for receiving the first electrical signal, so as to form a first signal current having the first message;
a microprocessor chip, disposed in the card and electrically connected to the coil, wherein the microprocessor chip is used to interpret the first signal current transmitted by the coil, thereby generating a second signal current having the second message for the coil, and the coil generates a second electrical signal according to the second signal current and returns the second electrical signal to the RFID reader; and
a switch, disposed between the coil and the microprocessor chip, for controlling an electrical connection between the coil and the microprocessor chip.

2. The card having the RFID tag as claimed in claim 1, wherein the switch is a resilient button.

3. The card having the RFID tag as claimed in claim 1, wherein the switch is a button.

4. The card having the RFID tag as claimed in claim 1, further comprising a display, disposed in the card and electrically connected to the microprocessor chip, wherein the display is controlled by the microprocessor chip to display the first message or the second message.

5. The card having the RFID tag as claimed in claim 4, wherein the switch is a resilient button.

6. The card having the RFID tag as claimed in claim 4, wherein the switch is a button.

7. The card having the RFID tag as claimed in claim 4, wherein the display is an electronic paper.

8. The card having the RFID tag as claimed in claim 7, wherein the switch is a resilient button.

9. The card having the RFID tag as claimed in claim 7, wherein the switch is a button.

10. A card having a RFID tag, for receiving a first electrical signal having a first message sent by a RFID reader and returning a second electrical signal having a second message to the RFID reader in response to the first electrical signal, the card having the RFID tag comprising:
a coil, disposed in the card, for receiving the first electrical signal, so as to form a first signal current having the first message;
a microprocessor chip, disposed in the card and electrically connected to the coil, wherein the microprocessor chip is used to interpret the first signal current transmitted by the coil, thereby generating a second signal current having the second message for the coil, and the coil generates a second electrical signal according to the second signal current and returns the second electrical signal to the RFID reader; and
an electronic paper, disposed in the card and electrically connected to the microprocessor chip, wherein the electronic paper is controlled by the microprocessor chip to display the first message or the second message.
